(19) United States
(12) Patent Application Publication
(10) Pub. No.: US 2025/0336053 A1
(43) Pub. Date: Oct. 30, 2025

(54) AUTOMATED SUBSTRATE DEFECT IDENTIFICATION USING MULTIPLE CLASSIFICATION ENGINE MODELS

(71) Applicant: Onto Innovation Inc., Wilmington, MA (US)

(72) Inventors: Longjiang Xiang, Tianjin (CN); Xuandong Cao, Wilmington, MA (US); Terry Voots, Wilmington, MA (US); Chien-Wen Chen, Hsinchu (TW); Xin Song, Wilmington, MA (US)

(21) Appl. No.: 19/006,597

(22) Filed: Dec. 31, 2024

Related U.S. Application Data
(60) Provisional application No. 63/640,423, filed on Apr. 30, 2024.

(51) Int. Cl. G06T 7/00; G06V 10/77; G06V 10/774; G06V 10/82; G06V 10/98

(52) U.S. Cl. CPC G06T 7/0004; G06V 10/7715; G06V 10/774; G06V 10/993; G06T 2207/20081; G06T 2207/20084; G06T 2207/30148; G06V 10/82; G06V 2201/06

(57) ABSTRACT

Methods and systems are provided for improving substrate defect classification in semiconductor manufacturing by using more than one machine learning model to classify substrate defect data. The method comprises a defect inspection module that captures substrate defect image data and a defect classification part that processes the data using more than one machine learning model. The output from each model is used to produce the final classified data. The defect score is calculated based on the classification results and this defect score is used to identify the misclassified substrate defect. The model can be updated after each inspection run cycle leading to increased accuracy and a lower escape rate.

### CROSS-REFERENCE TO RELATED APPLICATIONS

This patent application claims the benefit of, and priority to, U.S. provisional application No. 63/640,423 filed Apr. 30, 2024, the content of which is incorporated herein by reference in its entirety.

### TECHNICAL FIELD

The present disclosure generally relates to a method and system for classifying semiconductor substrate defects, and more specifically to automated substrate defect classification using multiple machine learning models.

### BACKGROUND

The manufacturing process involves numerous intricate steps, including photolithography, etching, deposition, and wafer bonding, among others. Each step requires specialized equipment and skilled technicians to ensure that the process is carried out correctly and that the final product meets the required specifications. Substrate defect classification is typically a step in the semiconductor manufacturing process to understand where defects might be.

Once defects have been detected by inspection, additional information about the defects is generated using defect review, which provides more detailed images of the defects with higher resolution capability than the inspection equipment used. This additional information is used to determine the type or classification of the defects, such as particle type defects, bridging type defects, scratch type defects, and more. However, it is important to note that defect classification is also performed based on information generated by inspection if the information is sufficient for defect classification or preliminary classification based on the limited amount of information generated by inspection. This helps to streamline the defect classification process and reduce the time and cost associated with defect review.

Conventionally, the substrate images obtained after automated optical inspection are reviewed and classified manually by operators. Manual classification of substrates and assigning labels for each one of them is an exhausting task which can lead to human errors, causing underkill or overkill of the dies. To overcome this, automated defect classification methods were developed.

### SUMMARY

Methods and systems are provided for improving substrate defect classification in semiconductor manufacturing by using more than one machine learning model to classify substrate defect data. The method comprises a defect inspection module that captures substrate defect image data and a defect classification part that processes the data using more than one machine learning model. The output from each model is used to produce the final classified data. The defect score is calculated based on the classification results and this defect score is used to identify the misclassified substrate defect. The model can be updated after each inspection run cycle leading to increased accuracy and a lower escape rate.

One embodiment of the present disclosure herein provides a method and system of a substrate defect using a multi-classification engine that combines at least two machine-learning models.

The present disclosure describes a method for identifying misclassified substrate defect images using multiple machine learning models. The method involves receiving a set of substrate defect image data and processing it to extract relevant features such as shape, color, and texture information. The processed data is then used to train multiple machine learning models, allowing them to learn patterns and features associated with different types of substrate defects. These updated models are then applied to classify the defects in the substrate defect image data, and any misclassified images are identified based on the results.

The present disclosure provides a continuous learning approach to keep the substrate defect classification model up-to-date with the latest defect types and patterns that change over time due to changes in semiconductor substrate manufacturing processes or new materials. The approach involves initially using a machine learning model with a large dataset of defect images to identify misclassified substrate defect data and then updating the model with new data as new defects are detected and classified during each inspection cycle. The continuous learning approach reduces false positives and false negatives, thereby increasing the accuracy throughput rate of the method over time

Still other advantages and benefits of the invention will become apparent to those skilled in the art upon a reading and understanding of the following summary, and detailed description.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

Please note that throughout like reference letters indicate corresponding parts in the various figures. The embodiments herein will be better understood from the following description with reference to the drawings, in which:

FIG. 1 illustrates a block diagram illustrating a substrate defect classification method.

FIG. 2 illustrates classification of a substrate defect while using the substrate defect method of FIG. 1.

FIG. 2A illustrates an example of different types of substrate defects.

FIG. 3 illustrates a flow chart showing aspects of the substrate classification identification method of FIG. 1.

FIG. 4 illustrates a flow chart depicting further aspects of the substrate classification method of FIG. 1.

FIG. 5 illustrates a block diagram of a defect image database of a system that can perform substrate classifications.

FIG. 6 illustrates aspects of a further example substrate defect classification method using multiple different machine learning models and/or different machine learning algorithms.

FIG. 7 illustrates an example substate defect classification model that uses a Convolutional Neural Network (CNN).

FIG. 7A illustrates an example of substrate defect classification results of the CNN of FIG. 7.

FIG. 8 illustrates an example substrate defect classification model that uses a k-Nearest Neighbor (KNN) algorithm.

FIG. 8A illustrates an example of substrate defect classification results of the KNN algorithm of FIG. 8.

FIG. 9 illustrates an example method that can be performed by a multi-classification model that performs classification based on a defect score.

FIG. 9A illustrates an example of substrate defect classification results that can be obtained by performing the method of FIG. 9.

FIG. 10 illustrates a system for implementing the substrate defect classification methods of the present disclosure.

### DETAILED DESCRIPTION

Methods and systems are provided for improving substrate defect classification in semiconductor manufacturing by using more than one machine learning model to classify substrate defect data. The method comprises a defect inspection module that captures substrate defect image data and a defect classification part that processes the data using more than one machine learning model. The output from each model is used to produce the final classified data. The defect score is calculated based on the classification results and this defect score is used to identify a misclassified substrate defect. The model can be updated after each inspection run cycle leading to increased accuracy and a lower escape rate (missed defects).

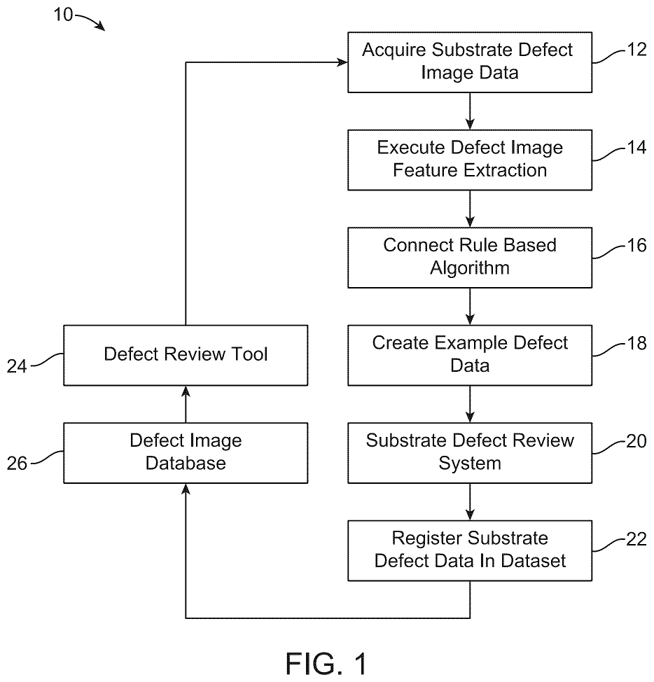

FIG. 1 illustrates a substrate classification method 10 where an image of the substrate containing defect is acquired in step 12 using a camera or any imaging device. The image processing is done for defect feature extraction in step 14 which involves image processing techniques like thresholding, edge detection, and morphological operations to identify and segment the defects from the substrate. After feature extraction, a rule-based algorithm in step 16 is used to classify the defects based on their characteristics by defining a set of rules based on the features of the defects like size, shape, color etc., such that the defects are classified into different categories. A defect classification example set is created in step 18 and classifications are labelled, which is given to the substrate defect review system in step 20 and then registered into the defect dataset in step 22. This dataset is used to update the defect image database in step 26 from where it is passed on to the defect review tool in step 24 for reviewing the classified substrates.

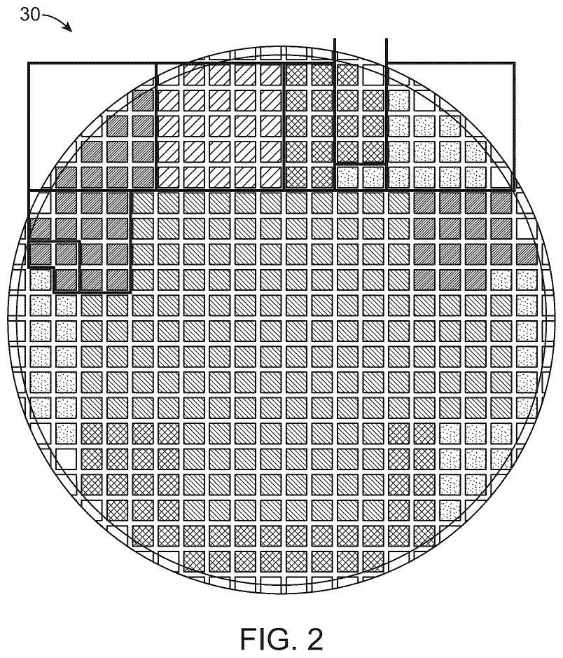

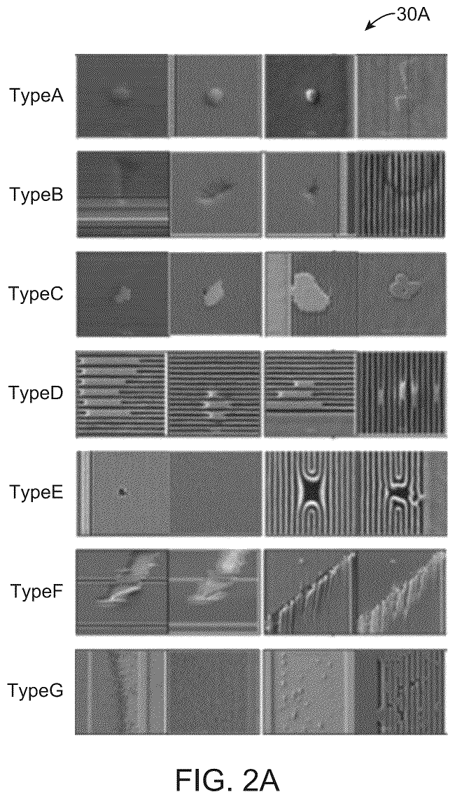

FIG. 2 illustrates classification of a substrate defect while using the substrate defect method of FIG. 1. For example, FIG. 2 illustrates the classification of substrate defect types 30. FIG. 2A illustrates an example of different types (in this example, seven different types including TypeA, TypeB, TypeC, TypeD, TypeE, TypeF, TypeG) of substrate defects. For example, FIG. 2A illustrates substrate defect types 30A include one or more of scratches, cracks, voids, particles, stains and pad defects.

Misclassification of substrates can occur due to the presence of noise patterns. Noise patterns are any random variations in the substrate such as variations in the manufacturing process, dust or dirt on the substrate, or imperfections in the imaging equipment. The presence of noise patterns makes it difficult to perform feature extraction of the images. Incorrectly extracted feature vectors cause the increase in escape rates of the classification method which can affect the accuracy and robustness of the method.

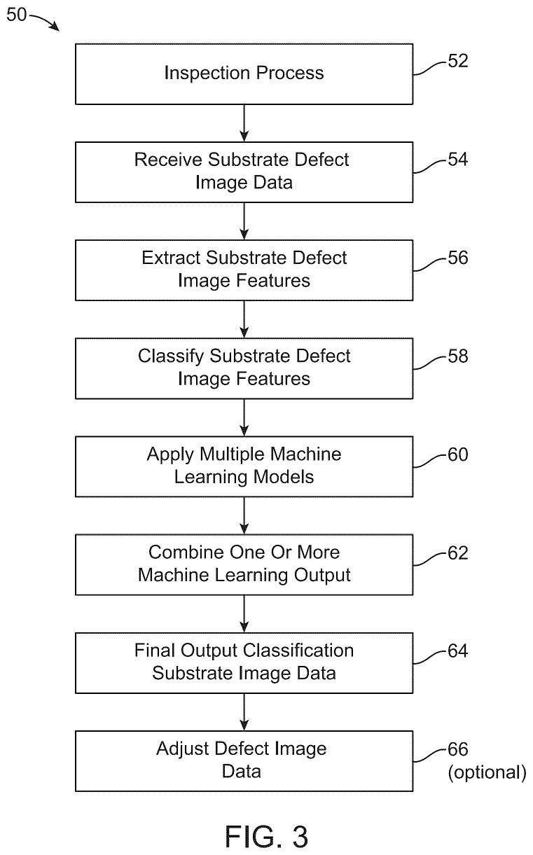

FIG. 3 illustrates a flow chart showing aspects of the substrate classification identification method of FIG. 1. In particular, FIG. 3 illustrates a flow diagram that represents a typical pipeline or method 50 for automated defect classification in semiconductor manufacturing. The different components work together to automatically detect and classify defects on substrates, which helps to ensure product quality and reduce manufacturing costs, which is explained in blocks 52-66. In connection with a method or process flow, the terms “block” and “step” may be used interchangeably herein.

The substrate inspection step 52 of the method 50 is responsible for capturing images of substrates with defects in block 54, which are then stored in the defect database. The defect database serves as a repository for all captured images and their associated metadata. The feature extraction module in block 56 processes the image data to extract relevant features such as shape, color, and texture information. This is an important step in the process because it helps to reduce the dimensionality of the data and extract only the most important features that are used to classify the defects in step 58 accurately. The machine learning model in block 60 is trained on the processed data to learn patterns and features associated with different types of substrate defects. In block 62, the inspection system uses supervised learning algorithms to train one or more machine learning models to recognize different types of defects based on their features. In block 64 final defect classification of the substrate images are executed based on their defect types. This uses the learned patterns and features to identify and classify defects accurately, providing valuable information that is used to optimize and adjust defect image date as in block 66, improving the quality of the manufacturing process.

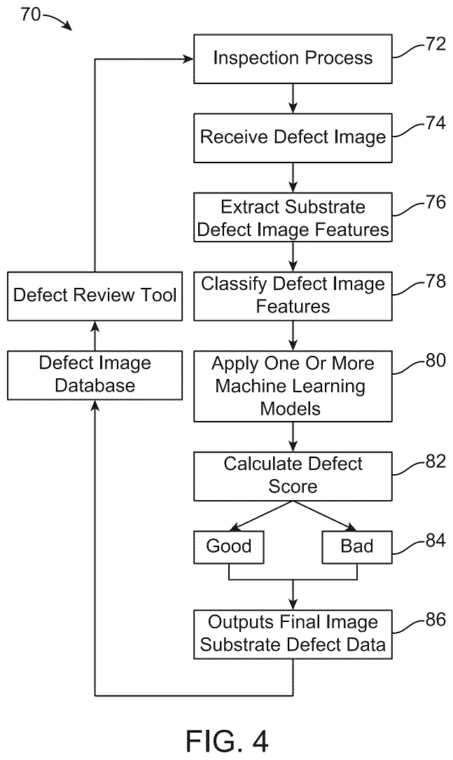

FIG. 4 illustrates a flow chart depicting further aspects of the substrate classification method of FIG. 1. In particular, FIG. 4 illustrates detailed steps of a classification identification method 70. The method 70 includes several components such as a substrate inspection method, a defect database, a feature extraction module, a machine learning model, and a defect classification module. The substrate inspection method in block 72 captures images of substrates with defects, which is received as the defect image data in block 74. The feature extraction module in block 76 preprocesses the image data to extract relevant features such as shape, color, and texture information where each feature vector represents a particular defect. These extracted features are used to classify the defect images in block 78. The machine learning model is trained on the preprocessed data to learn patterns and features associated with different types of substrate defects. The defect classification module applies one or more machine learning models in block 80 to the image data to classify the defects based on their type. The machine learning models that can be used are the neural network, decision trees, support vector machines, or random forest. Some specific examples of machine learning models can include convolutional Neural Network (CNN), a Deep Neural Network (DNN), a K-nearest neighbors (KNN), an Artificial Neural Networks (ANN), a recurrent Neural Network (RNN). The number of machine learning models and the type can be based on a user-based selection, triggered based on the defect, or triggered based on a defect score. For example, some defects may have the best certainty result when classified by a first machine learning model and then classified by a specified second machine learning model of a different type from the first machine learning model. This can happen for example because a first machine learning model does not classify certain defects well, but a second specified machine learning model of a different type does correctly classify the misclassified machine learning model.

The machine learning model can be trained to recognize defects based on features. In the training, the already classified defect images along with features are fed into the machine learning model so that the machine learning model can classify new defects based on its learning. The machine learning model can be trained to recognize patterns in the misclassified defect images and make accurate classifications based on those patterns. After the evaluation of the classification results, the machine learning model is used to inspect the misclassified substrate defects. Multiple machine learning models are trained on large datasets to classify between good and defective substrate images. The application of the second machine learning model compares the misclassified defect images with the classification results to identify the most likely classification for each defect and determines the defect score for each substrate defect. The plurality of misclassified substrate defect images is analyzed to determine the overall defect score, which represents the degree of accuracy in the defect detection process. The machine learning models that can be used are the neural network, decision trees, support vector machines, or random forest. One or more machine learning models are combined for improving the overall accuracy of the method.

Here the classification is performed based on a defect score value as shown in block 82. The defect score is calculated based on the severity and number of defects on the substrate. A higher defect score indicates a lower quality substrate, in which case that substrate is classified as bad or else if the defect score is lower, then the substrate is considered good in block 84. In some examples, the output of the substrate defect classification process in block 86 is stored in a database at block 87 of the method 70 where all the defect images and associated metadata are registered. In some examples, the classified defect data output obtained from the defect database is reviewed at block 89 of the method 70 and used to adjust the accuracy of the method for the next substrate classification cycle. The method is designed to continuously evaluate the performance and adjust the machine learning models for improved accuracy.

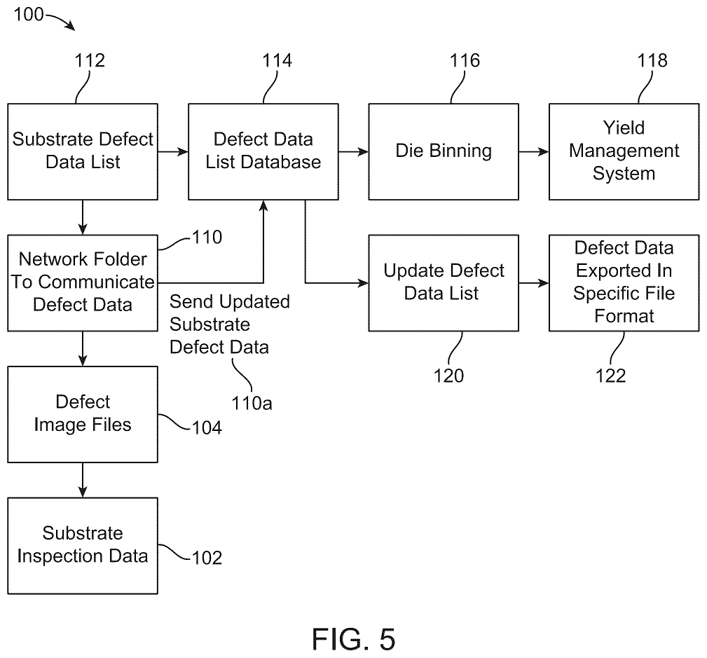

FIG. 5 illustrates a block diagram of a defect image database of a system that can perform substrate classifications. In particular, FIG. 5 illustrates a block diagram of a defect image database 100 in blocks 102-122. Substrate inspection data 102 from the inspection module contains the substrate images and metadata such as the location and type of defects, the size and shape of the defects or any other relevant parameters. Defect image data 104 are captured by scanning the substrates or dies and analyzed for defects such as scratches, particles or any pattern anomaly, which is then stored in a network folder. Network folder 110 is a shared location on a network where the defect images are stored and accessed. It is located on a local network or a cloud-based platform and is used to review the inspection results. Substrate defect data list 112 contains the list of all defects or anomalies that are detected during the inspection process and the list includes information such as the type of defect, the location on the substrate, and also the severity of the defect. The defect data list database 114 is created during the initial setup and calibration of the substrate classification method. The database includes a wide range of known defects such as missing components, misplaced components, incorrect polarity, incorrect soldering, cracks, scratches, debris, bridging and other issues that cause functional or performance issues in the semiconductor manufacturing process. The defect library is constantly being updated by the network folder data as shown by 110a and by the substrate defect data list.

Die binning 116 is a process of categorizing the substrates or dies based on their quality and defects. Each die is assigned to a specific bin based on the severity and the type of defects and the dies are sorted into different grades and determine which ones need further inspection. These binning values are used by a Yield Management System (YMS) 118 to analyze the overall yield of the manufacturing process and provide recommendations for process optimization like adjusting equipment settings or modifying the production process. YMS facilitates continuous improvement by providing real-time yield data analysis and process optimization methods to the substrate classification method. The updated defect data list 120 is converted into another file format KALRF (Known-Component Adaptive Logic Reduction Factor) 122 and is exported to multiple review tools.

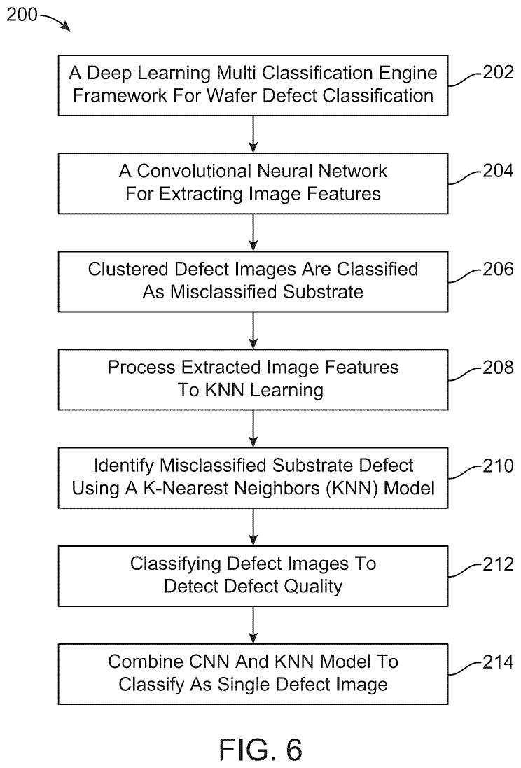

FIG. 6 illustrates aspects of a further example substrate defect classification method using multiple different machine learning models and/or different machine learning algorithms. In particular, FIG. 6 is an example embodiment of a method 200 using Deep learning multi-classification framework in block 202 which uses a combination of CNN and KNN. The convolution layers in the CNN do the preprocessing of the defect images for feature extraction in block 204 of the method 200. The output of the CNN is a feature vector of class probabilities for each input image. The feature vector extraction techniques include one or more principal component analysis (PCA), independent component analysis (ICA), or wavelet analysis. After the classification of substrate images based on extracted features, in block 206 of the method 200 clusters of the defect images are classified as misclassified substrate. The output of the CNN, corresponding to extracted image features, is used as input to a k-nearest neighbors (KNN) algorithm in block 208 of the method 200. The KNN algorithm identifies the k-nearest neighbors using similarity distance algorithms and identifies the misclassified substrate defects in block 210 of the method 200. In block 212 of the method 200, the output of the KNN algorithm is used for classifying defect images to detect defect image quality.

In block 214 of the method 200, the CNN and KNN algorithms are used in combination to classify a single defect image. For example, The CNN algorithm can be used first to classify any defects in the defect image. The resulting defects or specific defects classifications can then be analyzed by the KNN algorithm to classify further. Using the KNN algorithm can be more accurate for certain types of classifications or misclassifications by the CNN algorithm.

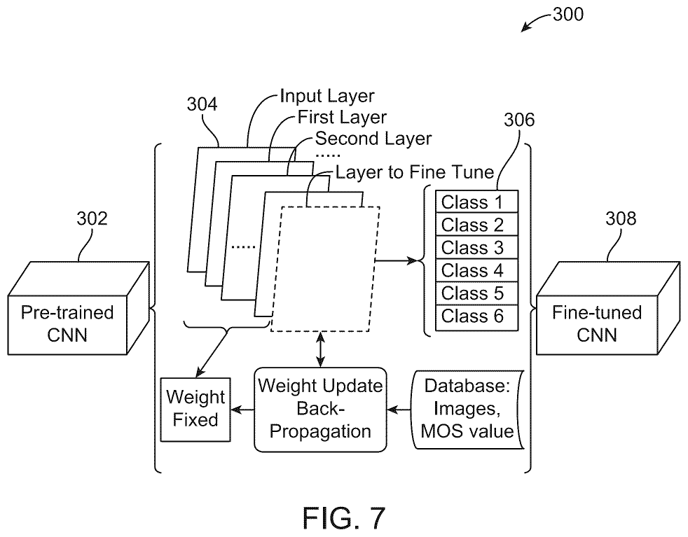

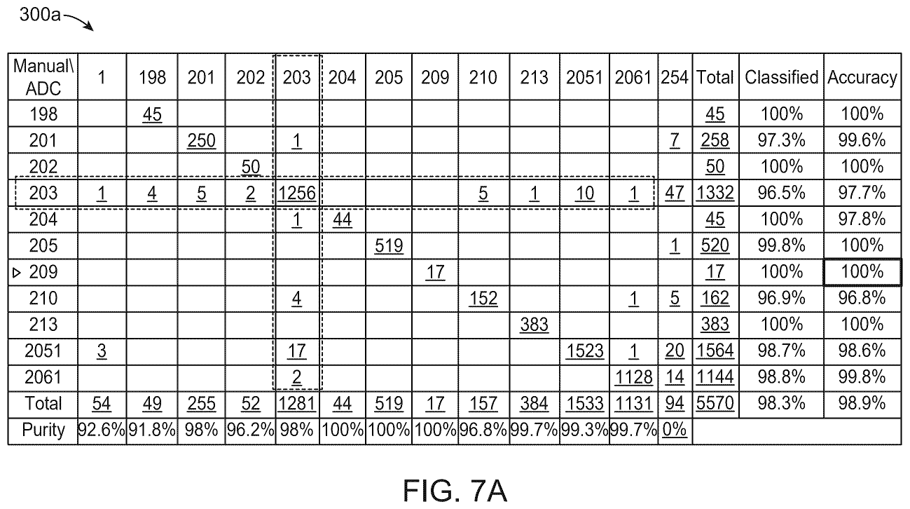

FIG. 7 illustrates an example substate defect classification model that uses a Convolutional Neural Network (CNN). In particular, FIG. 7 illustrates an example embodiment classification system using neural networks particularly using a Convolutional Neural Network (CNN) with a six-label classification model 300 where the pre-trained CNN 302 of the model 300 is used for feature extraction of the input substrate images. These features represent salient features of the substrate image which is used for substrate defect detection. Images of substrates with both good and bad regions are gathered, preprocessed and labelled with information on the defective regions. Image preprocessing involves resizing the images to a standard size, normalizing the pixel values, and applying various image enhancement techniques such as contrast adjustment and noise reduction. Once the preprocessed images have been obtained, the CNN is trained to detect the defects. The CNN typically consists of several layers 304, including convolutional layers, input layers and output layers. The preprocessed images are fed into the input layer of the CNN. The convolutional layers perform the feature extraction by applying a series of convolutional filters to the input image to extract features such as edges, corners, and textures. The output of each convolutional layer is a set of feature maps which represents different aspects of the input image.

After each convolutional layer, a pooling layer is used to reduce the size of the feature maps and to retain the most important features. The output from the pooling layer is flattened and fed into a series of fully connected layers which helps in establishing the complex relationships between the features and the labels. The output layer of the layers 304 is the final layer of the CNN, which has six classes corresponding to the six different defect categories 306. The fine tune layers 308 at the end of the CNN are responsible for classification. The fine tune layers take the features extracted by the convolutional layers and use them to classify the input image and label them.

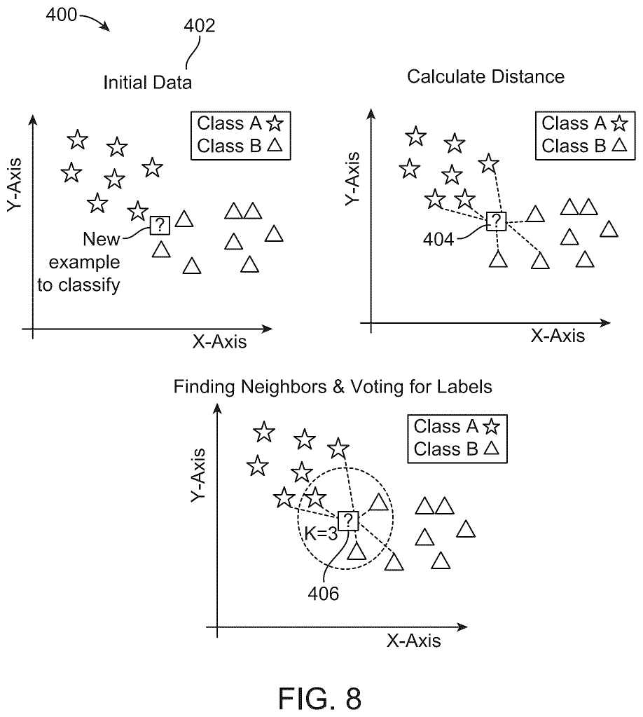

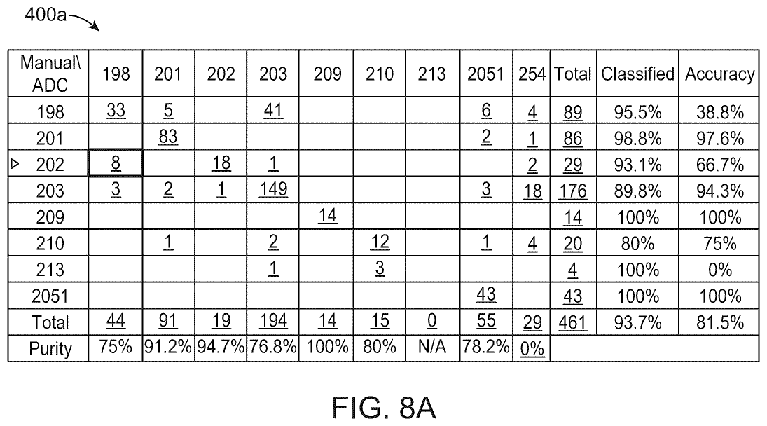

FIG. 8 illustrates an example substrate defect classification model that uses a k-Nearest Neighbor (KNN) algorithm. In particular, FIG. 8 is an example of a classification system using the k-nearest neighbor algorithm where the KNN algorithm 400 is used for classifying data points into two classes, A and B, with K=3. From a given set of training data points with known class 402, the distance between the unknown data point and each of the training data points is calculated using a distance metric, such as Euclidean distance or Manhattan distance 404. The distances are sorted in ascending order to get the K nearest neighbors, where K=3 in this case 406. The class of the unknown data point is determined based on the classes of its K nearest neighbors. The class with the most occurrences among the K neighbors is assigned to the unknown data point. Alternatively, a weighted vote is used, where the distances of the K neighbors are used as weights to determine the class. Output the predicted class of the unknown data point.

An example pseudocode of the KNN algorithm for classifying data points into classes A and B is as follows:

```
function knn_classify(data_point, training_data):
  distances = [ ]
  for point in training_data:
    distance = calculate_distance(data_point, point)
    distances.append((distance, point.class))
  sorted_distances = sorted(distances, key=lambda x: x[0])
  k_nearest_neighbors = sorted_distances[:3]
  class_counts = {“A”: 0, “B”: 0}
  for neighbor in k_nearest_neighbors:
    class_counts[neighbor[1] += 1
  if class_counts[“A”] > class_counts[“B”]:
    return “A”
  else:
    return “B”
//data_point is the unknown data point to be classified
training_data is a list of training data points with known classes
calculate_distance function calculates the distance between two data points. The
output of the function is the predicted class of the unknown data point, which is
either A or B//
```

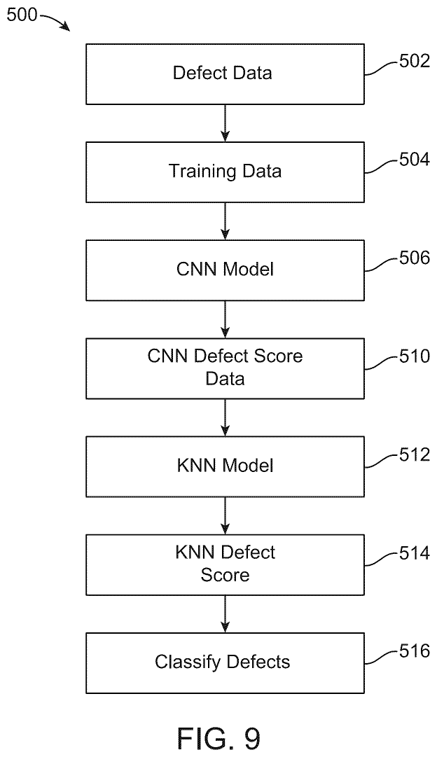

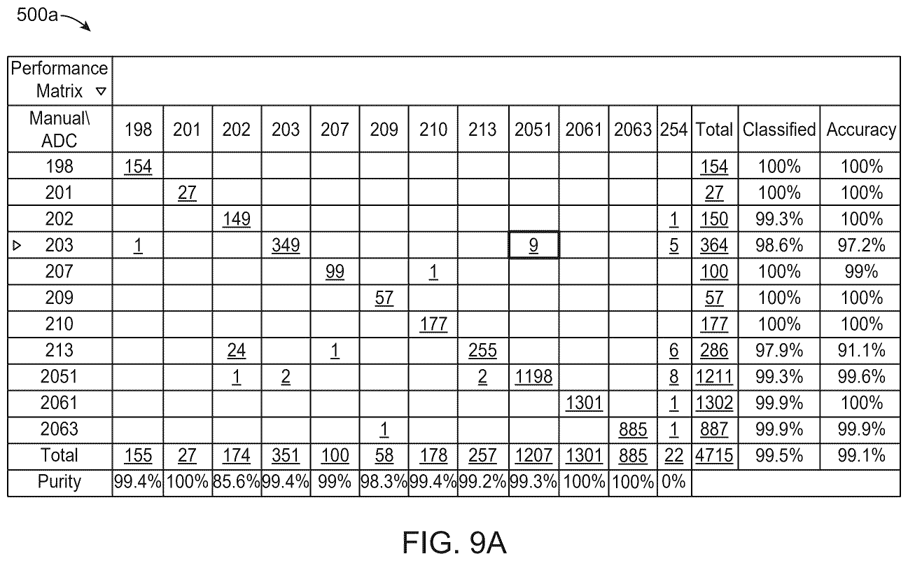

FIG. 9 illustrates an example method 500 that can be performed by a multi-classification model that performs classification based on a defect score. In particular, FIG. 9 illustrates a method performed by an example of a multi-classification engine which uses a defect score for identifying misclassified substrates. Initially, defect data is acquired in step 502 of the method 500 and machine algorithms are applied to train these data in the step 504 of the method 500. A CNN in step 506 of the method 500 is used as the first stage of classification where feature extraction is performed. The CNN defect score value is calculated in step 510 of the method 500 and defect score data is given as input to the second stage of classification which is a KNN model in step 512 of the method 500. The KNN defect score value is calculated in step 514 of the method 500 and based on the combined defect score of both models the final defect score is calculated and defect substrates are classified in step 516 of the method 500.

In the above examples, the misclassified substrate is denoted as an “escape code” in the system. Identification of the escape codes determines the escape rate of the system which is directly related to the efficiency of the system. For example, the lower the escape rate, the higher is the efficiency, whereas the higher the escape rate, the lower is the efficiency of the system.

FIG. 8A illustrates an example of substrate defect classification results of the KNN algorithm of FIG. 8. In particular, FIG. 8A illustrates an example of KNN classification system results 400a, which results capture only one escape code.

FIG. 7A illustrates an example of substrate defect classification results of the CNN of FIG. 7. In particular, FIG. 7A illustrates an example of CNN classification system results 300a 300a, which results captures two escape codes.

FIG. 9A illustrates an example of substrate defect classification results that can be obtained by performing the method of FIG. 9. In particular, FIG. 9A illustrates an example of combined CNN and KNN classification system results 500a, which results which capture three escape codes.

It is understood from examples that the embodiments of a system that use two-stage classification models, that combines CNN and KNN algorithms, can identify and capture the maximum number of escape codes, thereby advantageously providing a combined classification system that has a reduced escape rates and higher efficiency than individual systems.

The example embodiments illustrate the advantages of employing multi-classification systems for substrate defect classification. When used in combination, CNN is able to learn complex features from the substrate images that are informative for distinguishing between different defect categories which reduce the amount of manual feature engineering required for the task.

Another advantage is that the KNN algorithm is able to leverage the output of the CNN to perform a more fine-grained classification based on the similarities between different substrate images. This allows the system to make use of the correlations between different defect categories in the training dataset, leading to more accurate classification results.

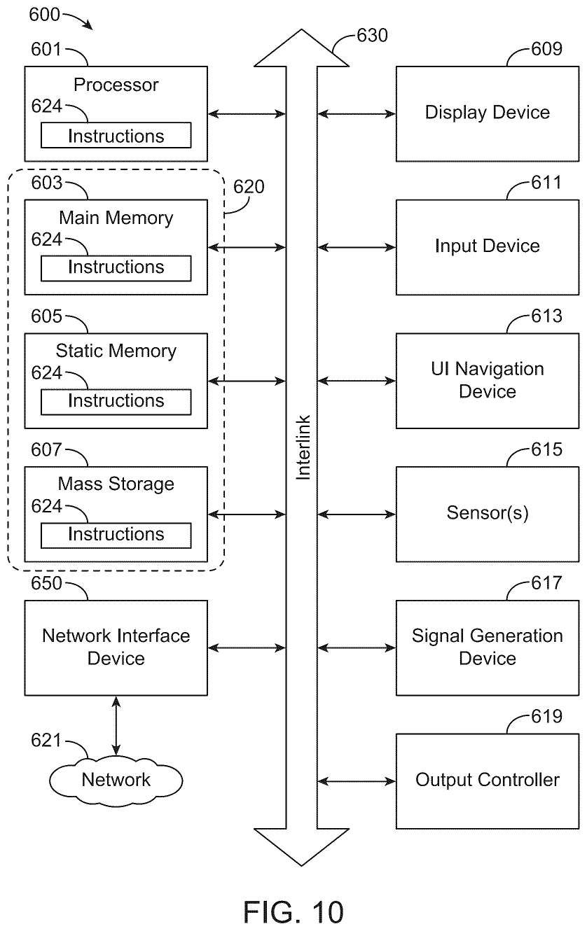

FIG. 10 illustrates a system for implementing the substrate defect classification methods of the present disclosure. In particular, the techniques shown and described herein can be performed using a portion or an entirety of a machine 600 as discussed below in relation to FIG. 10.

FIG. 10 shows an exemplary block diagram comprising a machine 600 upon which any one or more of the techniques (e.g., methodologies) discussed herein may be performed. In various examples, the machine 600 may operate as a standalone device or may be connected (e.g., networked) to other machines.

In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet device, a set-top box (STB), a personal digital assistant (PDA), GPU and FPGA, a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer-readable medium physically modified (e.g., magnetically, electrically, such as via a change in physical state or transformation of another physical characteristic, etc.) to encode instructions of the specific operation. In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 600 (e.g., computer system) may include a hardware-based processor 601 (e.g., a central processing unit (CPU), a graphics processing unit (GPU), a hardware processor core, or any combination thereof), a main memory 603 and a static memory 605, some or all of which may communicate with each other via an interlink 630 (e.g., a bus). The machine 600 may further include a display device 609, an input device 611 (e.g., an alphanumeric keyboard), and a user interface (UI) navigation device 613 (e.g., a mouse). In an example, the display device 609, the input device 611, and the UI navigation device 613 may comprise at least portions of a touch screen display. The machine 600 may additionally include a storage device 620 (e.g., a drive unit), a signal generation device 617 (e.g., a speaker), a network interface device 650, and one or more sensors 615, such as a global positioning system (GPS) sensor, compass, accelerometer, or other sensor. The machine 600 may include an output controller 619, such as a serial controller or interface (e.g., a universal serial bus (USB)), a parallel controller or interface, or other wired or wireless (e.g., infrared (IR) controllers or interfaces, near field communication (NFC), etc., coupled to communicate or control one or more peripheral devices (e.g., a printer, a card reader, etc.).

The storage device 620 may include a machine-readable medium on which is stored one or more sets of data structures or instructions 624 (e.g., software or firmware) embodying or utilized by any one or more of the techniques or functions described herein. The instructions 624 may also reside, completely or at least partially, within a main memory 603, within a static memory 605, within a mass storage device 607, or within the hardware-based processor 601 during execution thereof by the machine 600. In an example, one or any combination of the hardware-based processor 601, the main memory 603, the static memory 605, or the storage device 620 may constitute machine readable media.

While the machine-readable medium is considered as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 624 may further be transmitted or received (outputted or inputted) over a communications network 621 using a transmission medium via the network interface device 650 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., the Institute of Electrical and Electronics Engineers (IEEE) 802.22 family of standards known under the trade designation Wi-Fi, the IEEE 802.26 family of standards known under the trade designation WiMax), the IEEE 802.25.4 family of standards, peer-to-peer (P2P) networks, among others. In an example, the network interface device 650 may include one or more physical jacks (e.g., Ethernet, coaxial, or phone jacks) or one or more antennas to connect to the communications network 621. In an example, the network interface device 650 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

In the above description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments are combined with, or substituted for, one another in order to form varying modes of the embodiments of the disclosure. Thus, it is intended that the scope of the disclosure herein should not be limited by the particular embodiments described above.

1. A method for automatic classification of substrate defects, comprising:
receiving a plurality of substrate defect image data;
processing the plurality of substrate defect image data to extract features using at least one defect image feature extraction technique to create processed substrate defect image data;
classifying at least one defect in the processed substrate defect image data using a first machine learning model;
classifying the at least one defect in the processed substrate defect image data using a second machine learning model; and
outputting a final classified substrate defect image.

2. The method of claim 1, wherein the substrate defect image data includes one or more of wafers, substrates and panels.

3. The method of claim 1, wherein the substrate defect image data includes one or more of scratches, cracks, voids, particles, stains and pad defects.

4. The method of claim 1, wherein classification results of one or more of the classifying steps include a noise pattern that induces classification of a misclassified substrate defect that is reclassified by the second machine learning model.

5. The method of claim 1, wherein the first machine learning model comprises of at least one of a neural network, a decision tree, a support vector machine, or a random forest.

6. The method of claim 1, wherein each of the first machine learning model and the second machine learning model comprises one or more of a Convolutional Neural Network (CNN), a Deep Neural Network (DNN), a K-Nearest Neighbors (KNN), Artificial Neural Networks (ANN) or a Recurrent Neural Network (RNN).

7. The method of claim 1, wherein the second machine learning model is updated using classification results of noise patterns.

8. The method of claim 1, wherein the at least one defect image feature extraction technique comprises one or more of principal component analysis (PCA), independent component analysis (ICA), or wavelet analysis.

9. The method of claim 1, wherein a defect review image database collects real-time defect images of substrate defect classification data to determine a substrate defect score.

10. The method of claim 9, wherein the substrate defect score is determined based on a number of misclassified substrate defect images.

11. The method of claim 9, wherein the substrate defect score is stored in a Yield Management System (YMS) module.

12. The method of claim 1, further comprising updating the first machine learning model and the second machine learning model using the final classified substrate defect image for further successive inspection runtime cycles.

13. A method for automatic defect classification (ADC) of defects on or in substrates comprising:
receiving a plurality of substrate defect image data from a defect review image database;
processing the plurality of substrate defect image data to extract features to create processed substrate defect image data;
classifying at least one defect of the processed substrate defect image data using a first machine learning algorithm;
classifying another at least one defect of the processed substrate defect image data using a second machine learning algorithm, wherein the another at least one defect is different than the at least one defect classified by the first machine learning algorithm; and
outputting a final classified substrate defect image.

14. The method of claim 13, wherein classifying the processed substrate defect image data using the first machine learning algorithm and the second machine learning algorithm results in classification of more defects and a lower escape rate than one machine learning algorithm.

15. The method of claim 13 wherein noise in the processed substrate defect image data prevents the first machine learning algorithm from accurately classifying the another at least one defect.

16. The method of claim 1, further comprising using transfer learning techniques to transfer knowledge learned from one substrate type to another substrate type with similar defect types.

17. The method of claim 13, further comprising updating the first machine learning algorithm with noisy substrate defect images for identification of misclassified defect images.

18. The method of claim 13, wherein the first machine learning algorithm uses at least one of a neural network, a decision tree, a support vector machine, or a random forest.

19. The method of claim 13, wherein each of the first machine learning algorithm and the second machine learning algorithm comprises one or more of a Convolutional Neural Network (CNN), a Deep Neural Network (DNN), a K-Nearest Neighbors (KNN), Artificial Neural Networks (ANN) or a Recurrent Neural Network (RNN).

20. A system for automatic defect classification (ADC) of defects on or in semiconductor substrates, comprising:
at least one non-transitory machine readable medium that stores a first machine learning model and a second machine learning model;
at least one processor that receives substrate defect image data and extracts features from the substrate defect image data to create a processed substrate defect image that is run through the first machine learning model and then a second machine learning model to classify defects in the processed substrate defect image data;
a communication link for transceiving data between the at least one non-transitory machine readable medium and the at least one processor; and
a network interface device for outputting a plurality of classifications of defects.

21. The system of claim 20, wherein the first machine learning model comprises of at least one of a neural network, a decision tree, a support vector machine, or a random forest.

22. The system of claim 20, wherein each of the first machine learning model and the second machine learning model comprises one or more of a Convolutional Neural Network (CNN), a Deep Neural Network (DNN), a K-Nearest Neighbors (KNN), Artificial Neural Networks (ANN) or a Recurrent Neural Network (RNN).

23. A method for automatic classification of substrate defects, comprising:
receiving a plurality of substrate defect image data;
classifying, by a first machine learning model, a first defect in the substrate defect image data as a first defect classification;
classifying, by a second machine learning model, a second defect in the substrate defect image data as a second defect classification, the first machine learning model using a first machine learning algorithm not used by the second machine learning model, the second machine learning model using a second machine learning algorithm not used by the first machine learning model, the first defect classification being different from the second defect classification; and
outputting, based on the first defect classification and the second defect classification, a final classified substrate defect image,
wherein:
(i) the first defect and the second defect are the same defect and the first defect classification is a misclassification of the same defect; or
(ii) the first defect and the second defect are different defects.

24. The method of claim 23, wherein the first machine learning model comprises a Convolutional Neural Network (CNN) and not a K-Nearest Neighbors (KNN) and the second machine learning model comprises a CNN and not a KNN.
